(19) United States
(12) Patent Application Publication
(10) Pub. No.: US 2004/0239312 A1
(43) Pub. Date: Dec. 2, 2004

(54) Front wheel-induced motorcycle mileage counter inductor

(76) Inventors: Kuo-Hsin Su, Hsintien City (TW); Paul Huang, Foster City, CA (US); Paul Fei-Ta Chen, Sunnyvale, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/444,992

(22) Filed: May 27, 2003

(51) Int. Cl. G01C 22/00; G01B 7/30

(52) U.S. Cl. 324/171; 324/207.2

(57) ABSTRACT

A front wheel-induced motorcycle mileage counter inductor is constructed to include a magnetic device mounted in the outer end of the center shaft of the front wheel hub of the motorcycle, and a sensor formed of a Hall probe and mounted in a cover shell affixed to the front fork of the motorcycle around the outer end of the center shaft and electrically connected to the mileage counter of the motorcycle through a signal line and adapted to detect the amount of rotation of the magnetic device upon movement of the motorcycle and to output a signal indicative of the amount of rotation of the magnetic device to the mileage counter.

### BACKGROUND OF THE INVENTION

1. Field of the Invention

The present invention relates to motorcycle mileage counters and, more specifically, to a compact and durable front wheel-induced motorcycle mileage counter inductor, which accurately detects the amount of rotation of the front wheel during movement of the motorcycle.

2. Description of the Related Art

FIGS. 9 and 10 show a mechanical mileage counter driving mechanism for motorcycle according to the prior art. The mechanical mileage counter driving mechanism comprises a pair of driving lugs 232 bilaterally axially projecting from the end 23 of the center shaft 22 of the front wheel hub 21, a shell 5 mounted on the front fork of the motorcycle, the shell 5 having a tubular center shaft 52 set in line with the center shaft 22, the tubular center shaft 52 having a locating groove 53 extended around the periphery, a driven gear 54 mounted on the tubular center shaft 52 of the shell 5, the driven gear 54 having two outside cut faces 541 at two sides, an annular driving member 55 coupled to the driven gear 54, the annular driving member 55 having two inside cut faces 551 respectively abutted against the outside cut faces 541 of the driven gear 54 and two protruding lugs 552 extended from the periphery at two sides, a C-shaped retainer ring 531 fastened to the locating groove 53 to secure the driven gear 54 and the annular driving member 55 to the tubular center shaft 52 of the shell 5, and an output gear 542 mounted in a hole 51 in the shell 5 and meshed with the driven gear 54. When the center shaft 22 of the front wheel hub 21 rotated upon movement of the motorcycle, the driving lugs 232 are forced against the lugs 552 of the annular driving member 55, thereby causing the annular driving member 55 to rotate the driven gear 54 and then the output gear 542 and the connected mileage counter cable 56, and therefore the mileage counter counts the moving distance of the motorcycle. This design of mechanical mileage counter driving mechanism is still not satisfactory in function. One drawback of this design of mechanical mileage counter driving mechanism is its complicated structure and high manufacturing cost. Another drawback of this design of mechanical mileage counter driving mechanism is that the parts of the mechanical mileage counter wear quickly with use. Because the shell cannot protect the internal parts of the mechanical mileage counter driving mechanism against external dust and moisture, the internal parts of the mechanical mileage counter driving mechanism tend to be covered with dust and external objects. It is inconvenient to maintain or repair the internal parts of the mechanical mileage counter driving mechanism.

### SUMMARY OF THE INVENTION

The present invention has been accomplished under the circumstances in view. It is one object of the present invention to provide a front wheel-induced motorcycle mileage counter inductor, which accurately detects the amount of rotation of the front wheel of the motorcycle. It is another object of the present invention to provide a front wheel-induced motorcycle mileage counter inductor, which is friction-free and durable in use.

To achieve these and other objects of the present invention, the front wheel-induced motorcycle mileage counter inductor comprises an annular magnetic device mounted in the outer end of the tubular center shaft of the hub of the front wheel of a motorcycle, the annular magnetic device comprising a plurality of magnets equiangularly abutted against one another and alternatively arranged in reversed directions, a cover shell affixed to the front fork of the motorcycle around the outer end of the tubular center shaft of the hub of the front wheel of the motorcycle, the cover shell having a side duct; and a sensor formed of a Hall probe and mounted in the side duct of the cover shell and aimed at the annular magnetic device at one side and adapted to detect the amount of rotation of the annular magnetic device during movement of the motorcycle and to output a signal indicative of the amount of rotation of the annular magnetic device to the mileage counter of the motorcycle, the sensor comprising a signal line connected to the mileage counter of the motorcycle.

### BRIEF DESCRIPTION OF THE DRAWINGS

FIG. 1 is an exploded view of a front wheel-induced motorcycle mileage counter inductor according to the present invention.

FIG. 2 is an exploded view in an enlarged scale of the front wheel-induced motorcycle mileage counter inductor according to the present invention.

FIG. 3 is a schematic drawing showing the annular magnetic device installed in the outer end of the center shaft of the hub of the front wheel of the motorcycle according to the present invention.

FIG. 4 is a sectional view showing the front wheel-induced motorcycle mileage counter inductor installed according to the present invention.

FIG. 5 is a schematic drawing a status of the Hall probe before packing according to the present invention.

FIG. 6 is a schematic drawing a status of the Hall probe after packing according to the present invention.

FIG. 7 is a sectional view showing an alternate form of the front wheel-induced motorcycle mileage counter inductor installed according to the present invention.

FIG. 8 is a front view of the encoder wheel shown in FIG. 7.

FIG. 9 is an exploded view of a mechanical mileage counter driving mechanism for motorcycle according to the prior art.

FIG. 10 is a sectional assembly view of the mechanical mileage counter driving mechanism for motorcycle according to the prior art.

### DETAILED DESCRIPTION OF THE PREFERRED EMBODIMENT

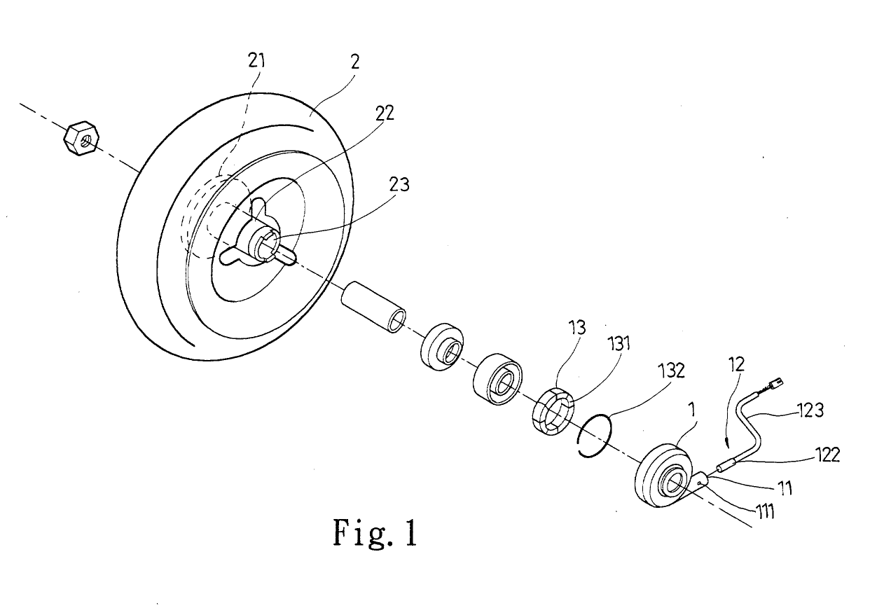

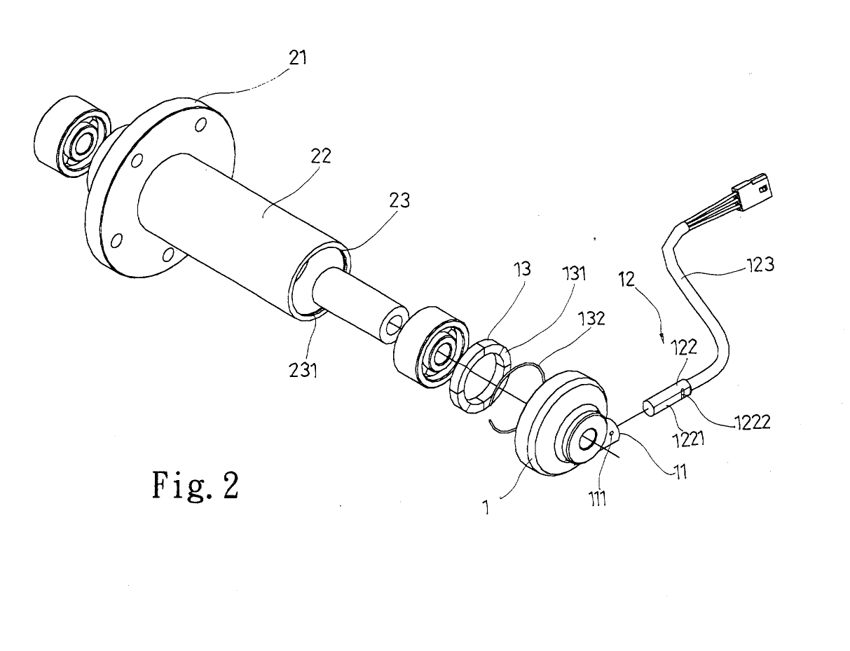

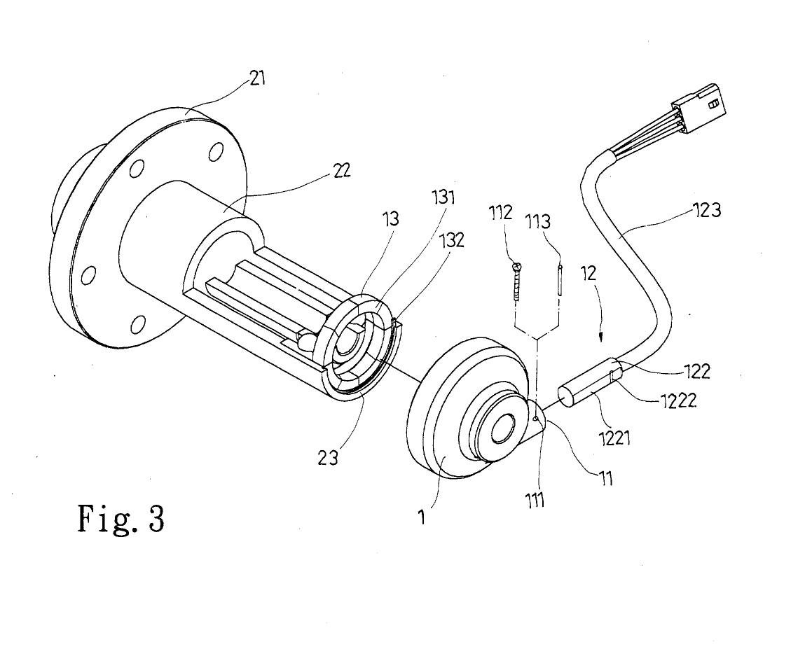

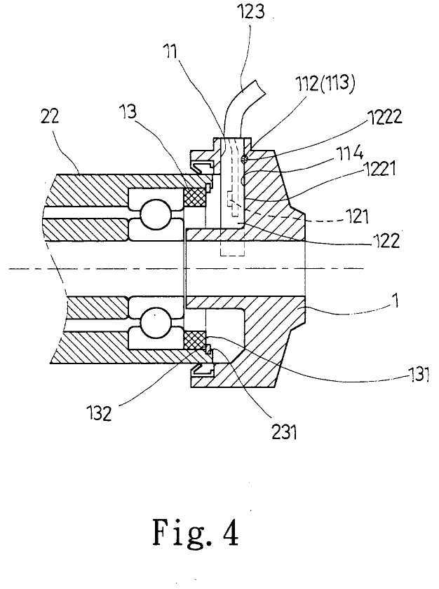

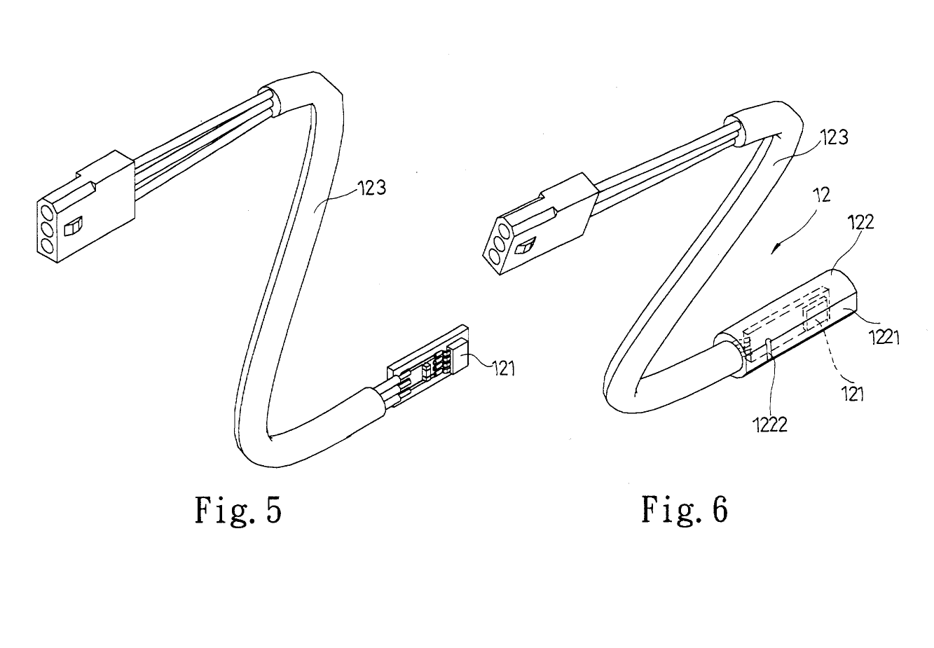

Referring to FIGS. 1˜6, a front wheel-induced motorcycle mileage counter inductor in accordance with the present invention is shown comprising an annular magnetic device 13 mounted in the outer end 23 of the center shaft 22 of the hub 21 of the front wheel 2 of a motorcycle (not shown), and a C-shaped retainer ring 132 mounted in an inside annular groove 231 in the outer end 23 of the center shaft 23 to secure the annular magnetic device 13 in position. The annular magnetic device 13 is comprised of a plurality of magnets 131 equiangularly abutted against one another and alternatively arranged in reversed directions. A cover shell 1 is affixed to the front fork (not shown) of the motorcycle and covered over the periphery of the outer end 23 of the center shaft 22 of the hub 21 without interfering with the rotation of the center shaft 22 upon movement of the motorcycle. The cover shell I has a side duct 11. A sensor 12 is mounted in the side duct 11 of the cover shell 1. According to this embodiment, the sensor 12 is a Hall probe 121 covered with a film 12, which protects the Hall probe 121 against moisture and dust. The Hall probe 121 has a flat face 1221 abutted against a flat face 114 in the side duct 11 of the cover shell 1, and a locating groove 1222 in the flat face 1221. A screw 112 or pin 113 is mounted in a hole 111 in the side duct 11 and engaged with the locating groove 1222 to hold down the Hall probe 121 in the side duct 11. When the annular magnetic device 13 rotated with the center shaft 22 of the hub 21, the Hall probe 121 detects the amount of rotation of the annular magnetic device 13, and outputs a signal indicative of the amount of rotation of the annular magnetic device 13 (the front wheel of the motorcycle) to the mileage counter of the motorcycle through a signal line 123.

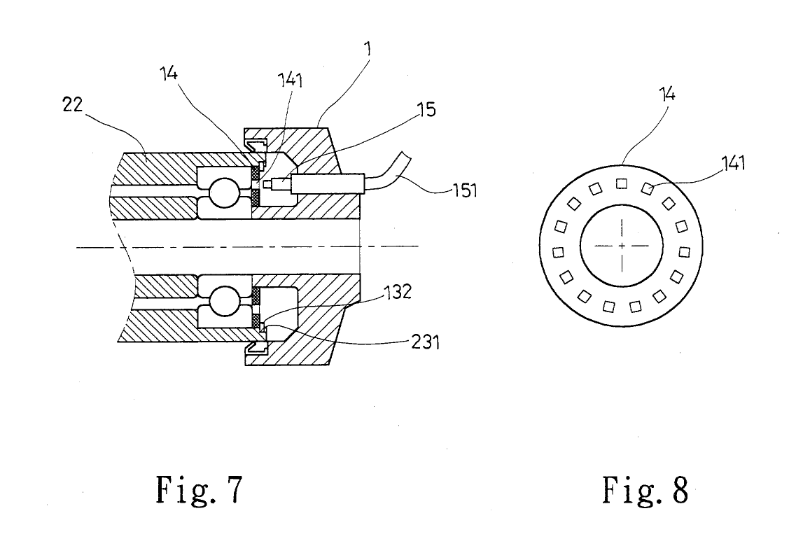

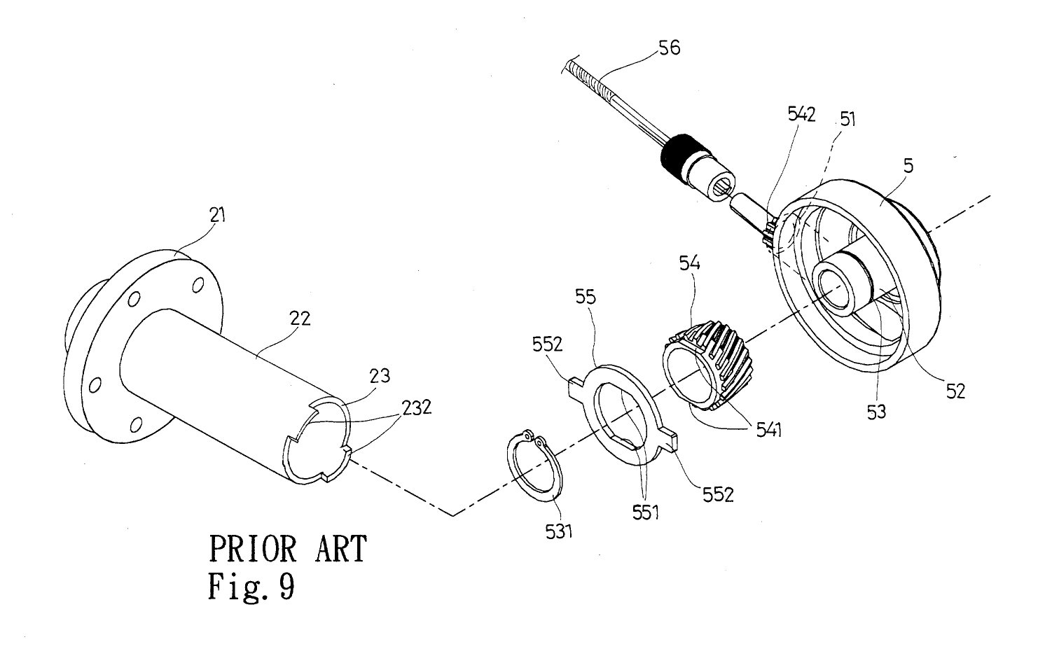

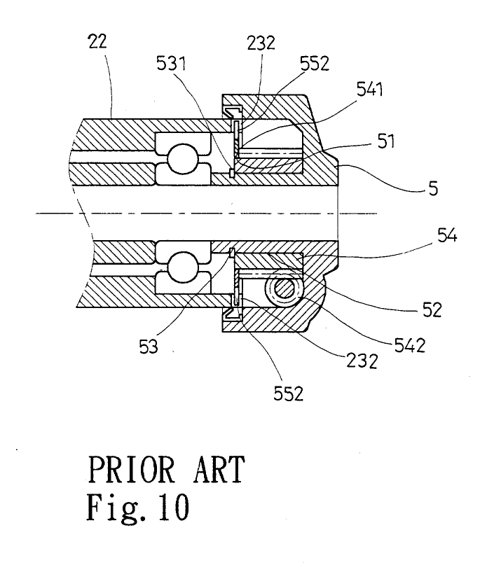

FIGS. 7 and 8 show an alternate form of the present invention. According to this embodiment, an encoder wheel 14 is mounted in the outer end 23 of the center shaft 22 of the hub 21, the encoder wheel 14 having a plurality of equiangularly spaced through holes 141 (or peripheral notches), and a proximity switch 15 is mounted in the cover shell 1 and adapted to detect the amount of rotation of the encoder wheel 14 upon each movement of the motorcycled and to output a signal indicative of the amount of rotation of the encoder wheel 14 to the mileage counter of the motorcycle through a signal line 151.

A prototype of front wheel-induced motorcycle mileage counter inductor has been constructed with the features of the annexed drawings of FIGS. 1˜8. The front wheel-induced motorcycle mileage counter inductor functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A front wheel-induced motorcycle mileage counter inductor installed in the tubular center shaft of the wheel hub of the front wheel and the front fork of a motorcycle and adapted to detect the amount of rotation of the front wheel of the motorcycle, comprising:
an annular magnetic device mounted in an outer end of the tubular center shaft of the hub of the front wheel of the motorcycle, said annular magnetic device comprising a plurality of magnets equiangularly abutted against one another and alternatively arranged in reversed directions;
a cover shell affixed to the front fork of the motorcycle around the outer end of the tubular center shaft of the hub of the front wheel of the motorcycle, said cover shell having a side duct; and
a sensor mounted in said side duct of said cover shell and aimed at said annular magnetic device at one side and adapted to detect the amount of rotation of said annular magnetic device during movement of the motorcycle and to output a signal indicative of the amount of rotation of said annular magnetic device to the mileage counter of the motorcycle, said sensor comprising a signal line connected to the mileage counter of the motorcycle.

2. The front wheel-induced motorcycle mileage counter inductor as claimed in claim 1, further comprising a C-shaped retainer ring mounted in an inside annular groove inside the tubular center shaft of the hub of the front wheel of the motorcycle to secure said annular magnetic device in position.

3. The front wheel-induced motorcycle mileage counter inductor as claimed in claim 1, wherein said sensor is comprised of a Hall probe covered with a layer of film.

4. The front wheel-induced motorcycle mileage counter inductor as claimed in claim 1, wherein said side duct of said cover shell has an inside flat face; said Hall probe has a flat face abutted against the inside flat face of said side duct.

5. The front wheel-induced motorcycle mileage counter inductor as claimed in claim 4, wherein said Hall probe has a locating groove in the flat face thereof; said cover shell comprises a mounting hole in said side duct, and a fastening element mounted in said mounting hole and engaged with the locating groove of said Hall probe to hold down said Hall probe inside said side duct of said cover shell.

6. A front wheel-induced motorcycle mileage counter inductor installed in the tubular center shaft of the wheel hub of the front wheel and the front fork of a motorcycle and adapted to detect the amount of rotation of the front wheel of the motorcycle, comprising:
an encoder wheel mounted in an outer end of the tubular center shaft of the hub of the front wheel of the motorcycle, said encoder wheel having a plurality of equiangularly spaced through holes;
a cover shell affixed to the front fork of the motorcycle around the outer end of the tubular center shaft of the hub of the front wheel of the motorcycle; and
a sensor mounted inside said cover shell and adapted to detect the amount of rotation of said encoder wheel during movement of the motorcycle and to output a signal indicative of the amount of rotation of said encoder wheel to the mileage counter of the motorcycle, said sensor comprising a signal line connected to the mileage counter of the motorcycle.

7. The front wheel-induced motorcycle mileage counter inductor as claimed in claim 6, further comprising a C-shaped retainer ring mounted in an inside annular groove inside the tubular center shaft of the hub of the front wheel of the motorcycle to secure said encoder wheel in position.

8. The front wheel-induced motorcycle mileage counter inductor as claimed in claim 1, wherein said sensor is a proximity switch.
